(19) United States
(12) Patent Application Publication
(10) Pub. No.: US 2014/0173699 A1
(43) Pub. Date: Jun. 19, 2014

(54) ASSIGNING PERMISSIONS BASED ON ORGANIZATIONAL STRUCTURE

(71) Applicant: MICROSOFT CORPORATION, Redmond, WA (US)

(72) Inventors: Michael Daly, Redmond, WA (US); Bryon Barnard, Snoqualmie, WA (US); Vikas Gupta, Bellevue, WA (US); Anatoliy Panasyuk, Bellevue, WA (US)

(73) Assignee: MICROSOFT CORPORATION, Redmond, WA (US)

(21) Appl. No.: 13/721,003

(22) Filed: Dec. 19, 2012

(51) Int. Cl. H04L 29/06

(52) U.S. Cl. CPC H04L 63/10
USPC 726/4

(57) ABSTRACT

Permission to access an organization's resources may be automatically assigned based on one or more structures within that organization. In one example, structural maps of an organization are received, where the structural maps indicate the reporting hierarchy of the organization, geographic subdivisions, substantive subdivisions, etc. Templates are received describing how permissions are to be assigned to particular substructures within the organization. The templates are then fitted to the organization, and permissions to access particular resources are assigned to members of the organization based on the templates. An administrator may modify the assigned permissions. Work requests may be routed to people based on which people have permission to access the resources involved in the work request.

### BACKGROUND

Organizations often have complex structures. Within an organization there may be many departments, many levels of management, and collateral relationship across chains of command. Organizations also have data and other resources that have to be managed by the people who work for the organization.

Typically, access to resources is controlled by a set of permissions indicating who has access to the resources. For example, there may be a set of electronic payroll records, and the employees of the payroll department may be given permission to access the payroll records. Typically, these permissions are assigned manually. Thus, if someone joins the payroll department, an administrator may have to manually grant that person permission to access the payroll records.

However, it is often the case that the permissions to be assigned to specific resources are closely related to the structure of the underlying organization. For example, if Steve works for the payroll department and Joe is Steve's supervisor, it makes sense that Joe would be given access to the set of payroll files to which Steve has access. In many situations, however, permissions to access resources have to be assigned manually.

### SUMMARY

Permissions to access resources may be assigned automatically based on the structure of an organization. A system that assigns permissions may receive one or more mappings of the structure of an organization, and one or more templates that describe how permissions are to be assigned to a particular type of substructure in the organization. Mappings may describe aspects of an organization such as its reporting hierarchy, geographic groupings, substantive groupings, etc. When a substructure in the organization matches a template, the members of that substructure may be assigned permissions in accordance with the template. An administrator may create exceptions to the template in situations where the permissions specified by the template are contrary to some other policy of the organization. When permissions are assigned based on a template, an association between the permissions and that template may be stored, which may facilitate making appropriate changes to the permissions if the template is later changed.

In addition to assigning permissions based on the structure of an organization, work requests may be routed based on the permissions that have been assigned. Particular types of work requests may make use of particular resources, and such work requests may be routed to those people who have control of the resources. Permissions to access an organization's resources are often assigned based on people's function within the organization, and work requests are often assigned to people who perform a particular function. Thus, the assignment of permissions and the routing of work requests may be treated as related issues.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram of an example relationship between structures within an organization and permissions to use the resources of that organization.

FIG. 2 is a block diagram of details of some example templates.

FIG. 3 is a flow diagram of an example process in which templates may be used to assign permissions to resources.

FIG. 4 is a flow diagram of an example process in which such relationships are used to route work requests.

FIG. 5 is a block diagram of an example system in which templates may be used to assign permissions to resources.

FIG. 6 is a block diagram of example components that may be used in connection with implementations of the subject matter described herein.

### DETAILED DESCRIPTION

Organizations such as corporations, universities, governments, normally have complex structures. For example, a corporation may have various product development groups, sales groups, service groups, financial groups, legal groups, etc. Similarly, a university may have various academic departments, various business and legal departments that support the university's mission, a facilities maintenance department, etc. Governments, of course, have complex, interrelated departments.

In addition to having an organizational structure, organizations often have resources whose use has to be controlled and managed. For example, any modern organization has information stored in electronic form on computers and other devices. Electronic files can be associated with rights and permissions that govern who can use the files, and what those people can do with the files. Although computer files are a canonical example of something that can be controlled by permissions that are managed on computers, many types of resources can be controlled in this way. For example, the same system that grants or denies access to files can treat physical objects (e.g., conference rooms, trucks, lawn equipment, etc.) as resources, and can manage access to those resources in effectively the same way as access to files are managed. Another example of a permission controlled system is an application; people in an organization may have to have permission to use an application or parts of an application. E.g., a cashier might have permission to use a cash register application, but the refund function of that application might involve a permission that is reserved for managers.

One feature of an organization is that access to resources is often closely aligned with the various organizational structures (and other relationship structures) within the organization. For example, there might be files that store the company's payroll. These files might be accessible to the employees in the accounting department who work directly with payroll issues, but probably are not accessible to employees outside of the accounting department. However, in addition to being accessible to the employees who work directly with the payroll, the payroll files might also be accessible to the manager who supervises those employees. Thus, permissions often follow the same hierarchy that exists within the organization. Moreover, in addition to the basic reporting hierarchy, there may be other structures in an organization. For example, the company might be organized into geographic regions, and it may be the case that any manager in the eastern division can supervise the eastern division's payroll employees when the payroll manager is out of the office. In this case, managers other than the payroll manager might have to have access to the payroll files even though these other managers are not technically in the chain of command of the payroll employees. In this case, these other managers are being given access to payroll files not because of their position in the organization's reporting hierarchy, but because of another structural aspect of the organization (i.e., geography). In other words, there are various structural aspects of an organization, and the question of who has access to which resources may be aligned with any combination of these structural aspects.

In systems that control access to resources, the process by which administrator grant permission to use a resource is generally separate from the process in which the organizational structures are specified. For example, each employee might have an account on the company's computer system. If A is the payroll manager and B, C, and D are his employees, then at some point in time the administrator of the computer system might arrange for A, B, C, and D to have permissions to access all of the files in the payroll folder. However, any changes to the permissions might have to be specified manually. Thus, if B leaves the company and is replaced with E, the permissions to use the payroll files have to be updated separately from the process by which the company's organizational chart or employee list is updated. Similarly, if the payroll manager's position is eliminated and the payroll employees are put under the supervision of the finance manager, F, the appropriate changes to the permissions governing the payroll files would have to be made manually. Some systems recognize the concept of a role, and can update permissions as people move in and out of that role, but do not infer permissions or roles from an underlying organizational or structural chart.

Typically, an organization may maintain an up-to-date organizational chart that reflects changes to the company's personnel and management structure in real time. However, changes to the permissions to use resources often lag behind changes to the company's structure, because changes to resource permissions are often implemented in reaction to changes to the organization. In short, issues of how a company is organized and who can access the company's resources are often closely related, but changes to the organization and changes to the resource permissions generally are not made in a unified process that reflects this relationship.

Moreover, the issue of how to route work within a company is closely aligned with the question of who has permission to access a resource. For example, if a company maintains a database of its intellectual property rights, and an employee in the research and development department wants to enter some information into that database, he may not know to whom to route the request. The proper recipients of the request may be those people who have permission to access the database of intellectual property rights. One way to view the situation is that the proper recipient of the request is “someone who has permission to access the database.” Or, in another example, if a person's parking space is blocked by snow and he wants to have the snow removed, the proper person to route the request to may be “someone who has permission to use the snowblower.” In these situations, a function within a company is very closely aligned with permission to use the appropriate resources.

The subject matter herein provides a way to tie together the concepts of (a) permission to use resources in an organization, (b) the existing structures in the organization, and (c) the process of routing work within the organization. In order to link these concepts together, a template may be created, where a template describes how resource permissions are assigned or inherited for some (possibly repeatable) substructure within an organization. For example, an organization might have a structure called a “work group” that contains a manager and his or her employees. The “work group” might exist in many places throughout the departments and divisions of the company. The template might say that the manager is given permission to access all resources that his employees can access. Or, the template might say that the manager is given permission to access all data resources (e.g., computer files) to which the employees have access, but not the physical resources (e.g., equipment) that the employees have access to. This later rule might make sense in the case where a person manages employees who operate equipment that the manager himself is not trained or licensed to operate. There are numerous variations on this theme. In general, a template defines a particular structure within an organization, and specifies how resource permissions can be derived from that structure. The template is used as a starting point for creating a new instance of a structure or substructure. The template can also be re-applied to an existing structure or substructure to aid in updating permissions to reflect changes in policies. Additionally, it is noted that the subject matter herein can be implemented without the use of templates. That is, permissions can be assigned based on the structure of an organization without using templates to describe repeating structures within the organization, but templates may be a convenient way to implement the assignment of permissions based on organizational structure.

The foregoing is an example of a hierarchical reporting structure within an organization, although there can be other structures that exist concurrently within the same organization, and from which permissions can be derived. For example, a company might operate several data centers throughout a country, and might divide the data centers into regions (e.g., north, southwest, south, etc.). Each data center might have a set of employees who have access to all of the data relating to the operation of that center. The manager of that center might also have access to those data. However, the structure of the organization might recognize the notion of a region, so that managers in the same region have access to the resources at other data centers in the region, so that the manager of one data center can step in to perform the function of another center's manager, in the event that one manager is unavailable. The notion of a region might not be recognized in the organization's hierarchical chain of command (since all of the managers of the various centers might report to the same company-wide officer), but permissions can still be assigned based on these regional relationships. In this sense, regional organization is a structure that exists concurrently with the company's hierarchical reporting structure, and both structure can be templatized and can be used to assign permissions to resources.

A template may be used to automate, or semi-automate, the process of assigning permissions to resources. Thus, a template can be applied to a particular structure to determine what specific employees and resources fit into the template. Once the template has been fit to the structure, a system can automatically give appropriate personnel permission to access appropriate resources. Additionally, an administrator can oversee the process of assigning permissions based on the template, and can create exceptions to the extent that it is appropriate to do so. For example, a template might say that an employee is given permission to access all files relevant to the employee's department. In the case of a payroll department, it might be the case that employees are to have access to all payroll records other than those of their boss. Thus, an administrator can create an exception to the permissions assigned by the template by removing, from the employee's, permission to access the boss's payroll records. Even when exceptions are made, the template that was initially used to create the permissions can continue to be associated with the permissions. In this way, when the template changes, the permissions that were assigned based on that template can be traced back to the underlying template, so that changes can be made accordingly when the template changes.

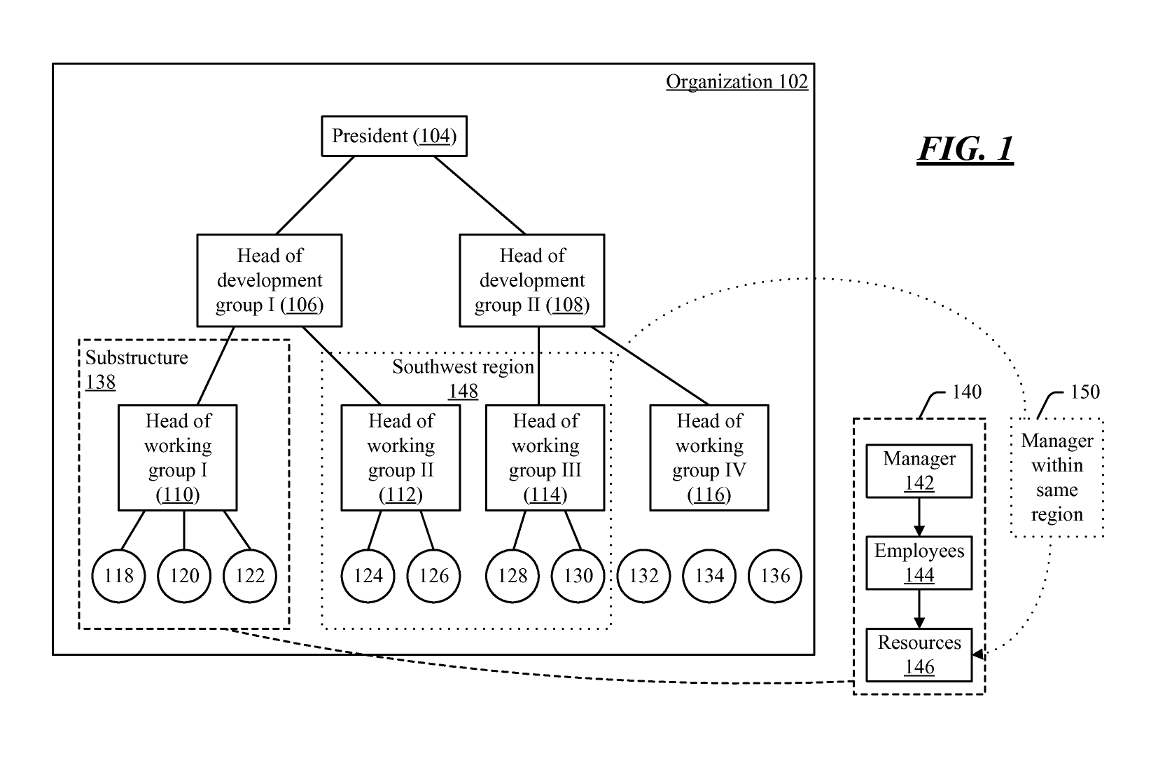

Turning now to the drawings, FIG. 1 shows an example relationship between structures within an organization and permissions to use the resources of that organization. Organization 102 may be any type of organization—e.g., a corporation, a government, a university, a charitable entity, etc. Various people and substructures exist within organization 102. In the example shown, organization 102 contains a president 104, development group heads 106 and 108, and work group heads 110, 112, 114, and 116. Additionally, organization 102 contains employees 118, 120, 122, 124, 126, 128, 130, 132, 134, and 136.

In addition to the specific people who are part of organization 102, organization 102 contains several substructures. For example, as shown in the organization chart, organization 102 recognizes the concepts of a development group and a work group. As can be seen, a work group has a work group head and several employees. A development group contains one or more work groups. Employees report to a work group manager, work group managers report to a development group manager, and development group managers report to the president. FIG. 1 shows work group I as an example of a substructure 138 within organization 102. It will be understood that a development group (including its work group heads and the work group employees) is also an example of a substructure. It will also be understood that work group and development group are substructures that occur more than once within organization 102. Thus, such substructures are referred to as being “repeatable.”

It may be the case that resource management within one instance of a substructure is similar to resource management with another instance of the same substructure. For example, work group I may have some set of files relating to that group's work, and work group II may likewise have some set of files relating to its work. Work groups I and II may manage their files very similarly. For example, each employee may have access to his own files, and the work group manager may have access to all of the files for the group's employees (as well as for the manager's own files). Since many work groups might choose to manage access to their files in this way, it may be convenient to have a template that represents this type of organization. In this way, when a new work group is created (or when the personnel of an existing workgroup changes), the permissions associated with the group's file can be created accordingly.

Template 140 is an example template for an arbitrary work group. Template 140 recognizes that a work group contains a manager 142 and employees 144. Template 140 indicates that employees have permission to access their resources 146, and that the manager 142 inherits the permissions of the employees (and, therefore, can access the resources that the employees can access). Of course, in a real world situation, the relationship between people in a work group and permissions assigned to resource might be more complex. For example, each employee might have his or her own resources, and there might also be resources shared among the group. Moreover, there might be certain types of resources to which a manager is not given access even if the employee does have access. What the example of template 140 shows, however, is that it is possible to recognize a particular structure within an organization and to create some general rules as to how that structure affects the assignment of permission to resources.

While FIG. 1 shows template 140 for a work group, other substructures within organization 102 could also have templates. For example, there could be a template for a development group that indicates that development group heads inherit the permissions given to the work group heads. Any type of template, recognizing any type of structure, could be created.

In addition to the hierarchical reporting structure of organization 102 (in which employees report to managers), organization 102 may have other types of structures that exist concurrently with the reporting structure. For example, organization 102 may recognize geographic regions. The existence of geographic regions may have implications for how permissions are assigned. In the example shown, work groups II and III are both part of southwest region 148. There may be reasons to have some resources that are shared across work groups in the same region (e.g., the manager of one work group can temporarily take over as manager of a nearby work group, in the event that a work group's manager is sick or away on business). Thus, there might be a template indicating that all managers in a geographic region inherit the permissions (or certain permissions) assigned to other managers at the same level in the same region. For example, template 150 indicates that permissions over resources 146 are to be given to managers who are in the same region as the manager who has primary responsibility for those resources. This type of arrangement might be of particular relevance for a service work group. For example, a company might operate several data centers, and the data centers might be grouped into geographic regions. The manager of a data center might have permission to access all of the files relating to the operation of that data center, but all of the data center managers in a particular region might have access to the resources of all of the other data centers in that region. In that way, any manager can cover for any other manager in the same region (by using his permissions to access relevant files remotely) in the event that the primary manager for a data center is unavailable.

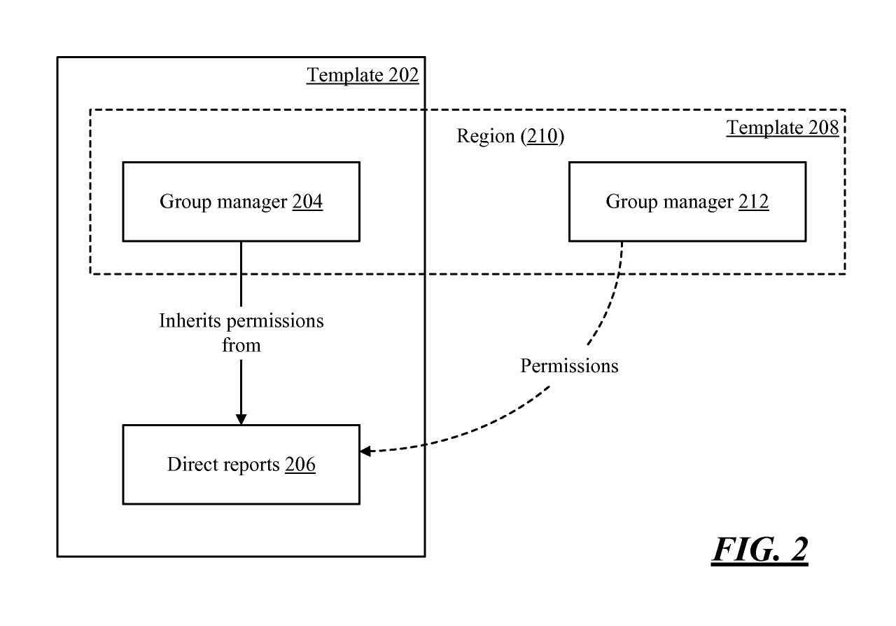

FIG. 2 shows details of some example templates, and how those templates are used with an organization structure to assign permission to resources.

Template 202 defines a relationship between a manager and the manager's direct reports. Thus, in template 202, a group manager 204 has direct reports 206. Template 202 specifies that group manager 204 inherits permissions given to direct reports 206. In effect, template 202 specifies that whatever permissions direct reports 206 have, group manager 204 will also have. An actual real-world policy might be more complicated than is shown in template 202. FIG. 2 merely provides an example of how an organizational structure could be recognized, and could be used to drive the decisions about what permissions are given to which people in the organization. In one example, template 202 might be applied to the relationship between the head of a work group and his employees, as shown in FIG. 1.

Template 208 defines a relationship between group managers 204 and 212 within the same geographic region 210. For the purpose of template 208, it is assumed that an organization recognizes the concept of a geographic region, and that the organization may have reason to provide some sharing of resources among managers in the same region. The example above in which access to the resources of data centers is shared among the managers of data centers in the same region is an example of such regionally-based resource sharing. In the example of FIG. 2, template 208 specifies that a group manager has permission to access resources of the direct reports of another manager in the same region.

FIG. 2 shows both template 202 based on an organization's hierarchical reporting structure, and template 208 based on the organization's regional structure. The relationship between these templates in FIG. 2 demonstrates that an organization may have plural structures that exist concurrently, and that permission to access resources may be driven by both types of structures.

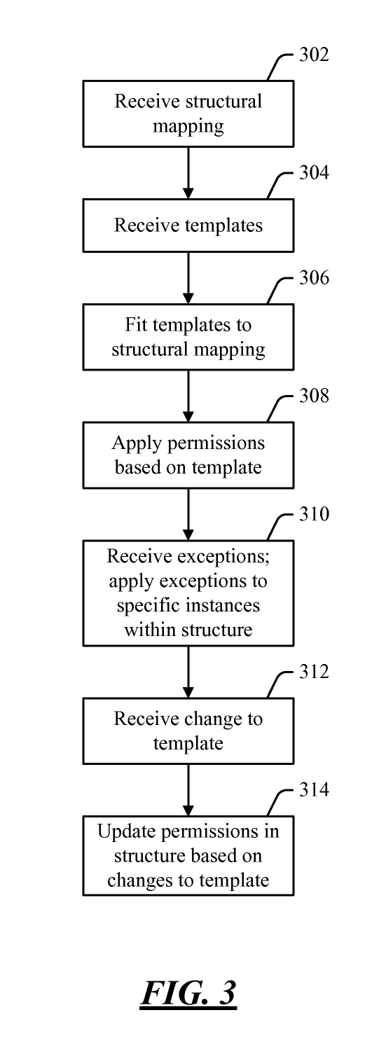

FIG. 3 shows an example process in which templates may be used to assign permissions to resources.

At 302, a structural mapping is received. The structural mapping may be an organization's reporting hierarchy, but could be any other type of structural mapping. For example, an organization might recognize the concept of a geographic region, in which case the structural mapping might indicate which entities in the organization are parts of particular regions. Or, the organization might recognize that certain aspects of the organization handle the same substantive subject matter. E.g., a large conglomerate might recognize that some areas of the company handle food products and other areas handle construction machinery. These different subject matter areas might not follow any particular geographic boundaries, and might traverse several different chains of command, and yet there might be some sharing of resources among groups based on their shared substantive interests. Thus, there might be a structural mapping that is based on these types of subject-matter groupings. Any type of structural mapping could be received at 302.

At 304, templates are received. Templates, as explained above, describe particular structural relationships within an organization, and describe how permissions are to be assigned based on these structural relationships.

At 306, the templates are fitted to the structural mappings. For example, a template might show a work group manager and his or her direct reports. For a structural mapping that constitutes a graph of the companies reporting relationships, that template could be fitted to work groups in the graph. Or, as another example, a template might specify the relationship among managers at the same level within a particular geographic region. If the structural mapping shows which entities in the organization are in particular geographic regions, then the template could be fitted to all groupings of managers who are in the same region and are at the same level.

Once the template has been fitted to the structural mapping, the template may be applied to that structure (at 308). Thus, if a template specifies that a work group manager is to inherit those permissions given to his or her direct reports, then permissions could be assigned to the manager in accordance with that template.

A template might be a reasonable starting point for assigning permissions, but a human administrator may have the final word on which permissions are actually assigned. Thus, after the template is applied, an administrator might specify exceptions to the permissions that would otherwise be assigned by the template (at 310). For example, it might generally be the case that each manager in the region can access all of the resources of anyone who reports to any other manager in the region. However, there might be an employee who has a legal claim or other adversarial issue with a particular manager, so the company might make a decision that that manager is not to have access to that employee's files. Thus, the template might presumptively give the manager permission to access the employee's resources, but an administrator may override the template in the circumstance described above.

After permissions have been assigned based on the template and on the exceptions, at some later point in time a change to the template might be received (at 312). For example, if the template specifies the relationship between a work group manager and his direct reports, a decision might be made within the company that managers are no longer to receive permission to access the files that their direct reports can access. If the template previously specified that work group managers do have such permission, then the new policy may be reflected as a change in the template. When such a change to the template is received, those permissions that have been assigned based on the template may be updated to reflect the change (at 314). In one example, the updating is performed automatically when the template changes. In another example, an administrator may be alerted that there has been a change to the template on which certain permissions are based, and the administrator may make the decision as to whether permissions that have already been assigned based on the old version of the template are to be changed.

In one example, templates may be named, and the permissions that have been assigned based on a particular template may be durably associated with that template. Thus, if a template is named “work group” and permission have been assigned based on that template, those permission may be associated with the “work group” template. Thus, if the “work group” template changes, any permissions that were assigned based on that template can be found readily, and can be updated to reflect the changed template.

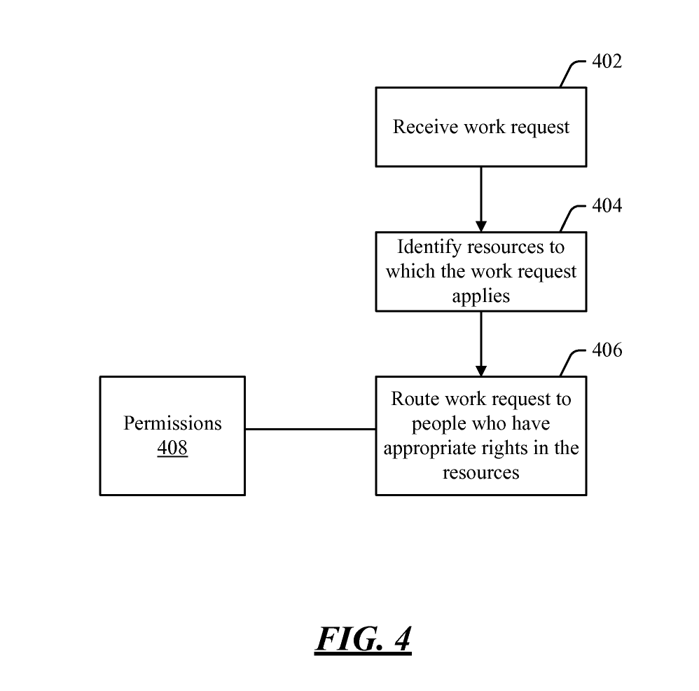

As noted above, the relationship between an organization's structure and the permissions assigned to its resources may be used to route work requests to appropriate people within an organization. FIG. 4 shows an example process in which such relationships are used to route work requests.

At 402, a work request is received. For example, a work request might be a request to enter certain information into a database, to restart a particular online service, or to have snow removed from a walkway. In any of these situations, responding to the work request may involve the use of resources to which access is controlled by permissions. For example, entering information into a database involves having access to that database. Restarting an online service may involve having administrator-level permission on the machines on which the service runs, or access to certain passwords. Removing snow may involve having permission to use a company's snowblower (which is also an example of a resource to which access may be controlled). Thus, at 404, the resources to which the work request pertains are identified. At 406, the request is routed to people who have appropriate rights to access the resources. This routing might be performed using the permissions 408 that have been assigned within the organization. For example, if the request is to enter information into a database, the routing of the request might start with an inquiry as to who has permission to access that database. Once the list of people who have permission to access the database has been determined, the request may be routed to those people. It is noted that the time for which a particular person is appropriate to respond to a request (and, therefore, the time for which that person might have permission over the appropriate resources) could be temporary. For example, there might be a two-day window during which person A is filling in for person B. During that short time window, person A may have permission to access certain records that are normally accessible only to person B. During that time window, it may be the case that person A can access the records and also that requests to use those records will be routed to person B.

It is noted that the security and routing information can be used as part of a workflow. For example, if the workflow involves a financial transaction, there may be different people who approve transactions depending on the amount of money involved. A particular workflow request may include all of the parameters that allow this type of routing decision can be made, and the request can be routed accordingly. E.g., a person with a request to approve a transaction involving a $10,000 purchase can simply be routed to whomever has permission to approve a purchase that large. The rules for determining who to route the request to (and for determine who has permission over the relevant resources) can be arbitrarily complex, and the request can be routed without the requestor knowing the identity of the person to whom the request is routed.

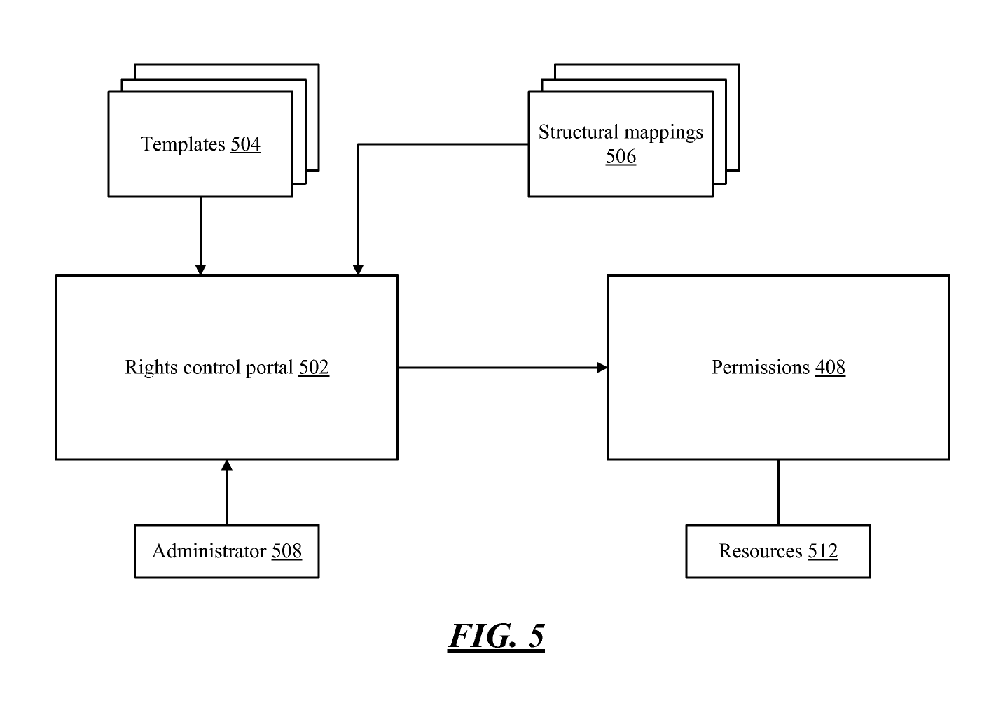

FIG. 5 shows an example system in which templates may be used to assign permissions to resources. A rights control portal 502 may be used by an administrator 508 to assign permissions to access resources. Rights control portal 502 may receive templates 504 and structural mappings 506. The nature of templates and structural mappings is described above. Rights control portal 502 may determine how the templates apply to the structural mappings, and may apply permissions 408 to the various resources 512 based on the templates. Administrator 508 may examine the permissions that would be applied to the resources in accordance with the templates, and may modify make any modifications that the administrator deems appropriate. Rights control portal may contain appropriate interfaces that allow an administrator to accept the permissions assigned based on the templates, or to make changes to those permissions.

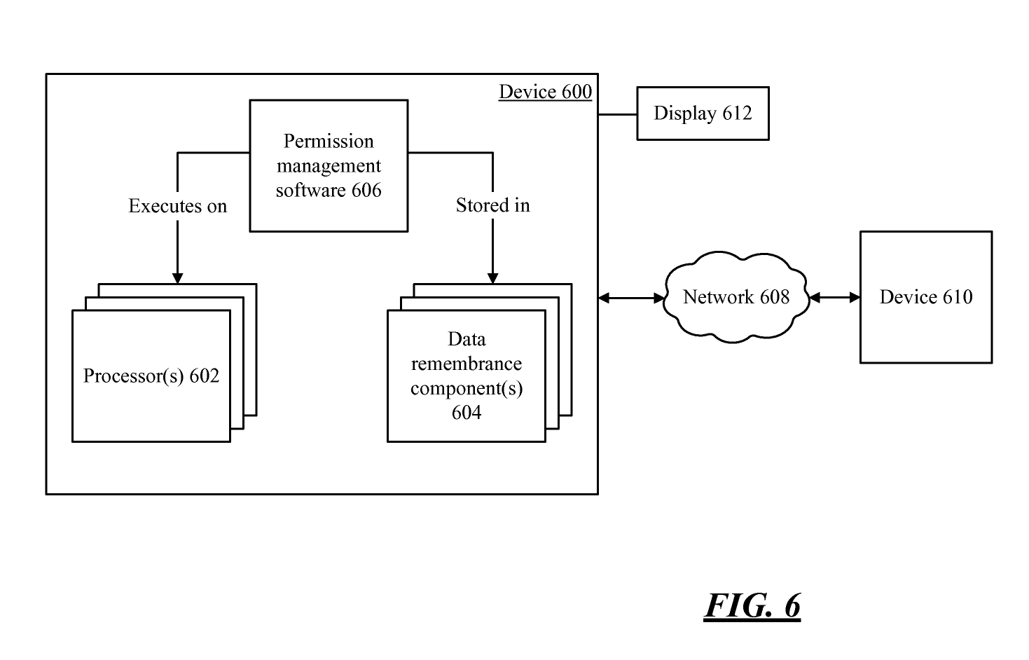

FIG. 6 shows an example environment in which aspects of the subject matter described herein may be deployed.

Device 600 includes one or more processors 602 and one or more data remembrance components 604. Device 600 may be any type of device with some computing power. A smart phone is one example of device 600, although device 600 could be a desktop computer, laptop computer, tablet computer, set top box, or any other appropriate type of device. Processor(s) 602 are typically microprocessors, such as those found in a personal desktop or laptop computer, a server, a handheld computer, or another kind of computing device, but could be any types of processors (e.g., supercomputers, embedded computers, etc.). Data remembrance component(s) 604 are components that are capable of storing data for either the short or long term. Examples of data remembrance component(s) 604 include hard disks, removable disks (including optical and magnetic disks), volatile and non-volatile random-access memory (RAM), read-only memory (ROM), flash memory, magnetic tape, etc. Data remembrance component(s) are examples of computer-readable (or device-readable) storage media. Device 600 may comprise, or be associated with, display 612, which may be a cathode ray tube (CRT) monitor, a liquid crystal display (LCD) monitor, or any other type of monitor. Display 612 may be an output-only type of display; however, in another non-limiting example, display 612 may be (or comprise) a touch screen that is capable of both displaying and receiving information.

Software may be stored in the data remembrance component(s) 604, and may execute on the one or more processor(s) 602. An example of such software is permission management software 606, which may implement some or all of the functionality described above in connection with FIGS. 1-5, although any type of software could be used. Software 606 may be implemented, for example, through one or more components, which may be components in a distributed system, separate files, separate functions, separate objects, separate lines of code, etc. A device (e.g., smart phone, personal computer, server computer, handheld computer, tablet computer, set top box, etc.) in which a program is stored on hard disk, loaded into RAM, and executed on the device's processor(s) typifies the scenario depicted in FIG. 6, although the subject matter described herein is not limited to this example.

The subject matter described herein can be implemented as software that is stored in one or more of the data remembrance component(s) 604 and that executes on one or more of the processor(s) 602. As another example, the subject matter can be implemented as instructions that are stored on one or more device-readable media. Such instructions, when executed by a phone, a computer, or another machine, may cause the phone, computer, or other machine to perform one or more acts of a method. The instructions to perform the acts could be stored on one medium, or could be spread out across plural media, so that the instructions might appear collectively on the one or more computer-readable (or device-readable) media, regardless of whether all of the instructions happen to be on the same medium.

Computer-readable media includes, at least, two types of computer-readable media, namely computer storage media and communication media. Likewise, device-readable media includes, at least, two types of device-readable media, namely device storage media and communication media.

Computer storage media (or device storage media) includes volatile and non-volatile, removable and non-removable media implemented in any method or technology for storage of information such as computer readable instructions, data structures, program modules, or other data. Computer storage media (and device storage media) includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that may be used to store information for access by a computer or other type of device.

In contrast, communication media may embody computer readable instructions, data structures, program modules, or other data in a modulated data signal, such as a carrier wave, or other transmission mechanism. As defined herein, computer storage media does not include communication media. Likewise, device storage media does not include communication media.

Additionally, any acts described herein (whether or not shown in a diagram) may be performed by a processor (e.g., one or more of processors 602) as part of a method. Thus, if the acts A, B, and C are described herein, then a method may be performed that comprises the acts of A, B, and C. Moreover, if the acts of A, B, and C are described herein, then a method may be performed that comprises using a processor to perform the acts of A, B, and C.

In one example environment, device 600 may be communicatively connected to one or more other devices through network 608. device 610, which may be similar in structure to device 600, is an example of a device that can be connected to device 600, although other types of devices may also be so connected.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. A computer-readable medium that stores executable instructions for managing permissions for resources, the executable instructions, when executed by a computer, causing the computer to perform acts comprising:
receiving a structural mapping of an organization;
assigning permissions to resources in said instance based on said structural mapping and based on a representation of how permissions for resources relate to said structural mapping; and
granting or denying access to a resource based on said permissions.

2. The computer-readable medium of claim 1, said structural mapping comprising a reporting hierarchy within said organization, there being a template that defines a reporting relationship within said organization, said template being used to assign said permissions.

3. The computer-readable medium of claim 1, said structural mapping comprising a geographic grouping within said organization, there being a template that defines a relationship among entities in said organization that are in a same geographic region as each other, said template being used to assign said permissions.

4. The computer-readable medium of claim 1, said structural mapping comprising a substantive grouping within said organization, there being a template that defines a relationship among entities in said organization that work in a same substantive area, said template being used to assign said permissions.

5. The computer-readable medium of claim 1, there being a template that defines a repeatable substructure that exists within said organization, said template specifying how permissions for resources relate to said substructure, said acts further comprising:
receiving an update to said template.

6. The computer-readable medium of claim 1, said acts further comprising:
receiving changes to said permissions, said permissions being assigned to said resources based on said changes.

7. The computer-readable medium of claim 1, there being a template that defines a repeatable substructure that exists within said organization, said template specifying how permissions for resources relate to said substructure, said acts further comprising:
associating assigned permissions with a name of said template.

8. A method of routing work requests based on permissions, the method comprising:
using a processor to perform acts comprising:
receiving a structural mapping of an organization;
receiving a template that represents a repeatable substructure that exists within said organization, said template specifying how permissions for resources relate to said substructure;
fitting said template to an instance of said substructure;
assigning permissions to resources in said instance based on said structural mapping;
receiving a work request;
identifying a resource to which said work request applies; and
routing said work request to people who have permission to access said resource.

9. The method of claim 8, said structural mapping comprising a reporting hierarchy within said organization, said template defining a reporting relationship within said organization.

10. The method of claim 8, said structural mapping comprising a geographic grouping within said organization, said template defining a relationship among entities in said organization that are in a same geographic region as each other.

11. The method of claim 8, said structural mapping comprising a substantive grouping within said organization, said template defining a relationship among entities in said organization that work in a same substantive area.

12. The method of claim 8, said acts further comprising:
receiving changes to said permissions, said permissions being assigned to said resources based on said changes.

13. The method of claim 8, said acts further comprising:
associating assigned permissions with a name of said template.

14. A system for managing permissions for resources, the system comprising:
a memory;
a processor; and
a component that is stored in said memory, that executes on said processor, that receives a structural mapping of an organization, that receives a template that represents a repeatable substructure that exists within said organization, said template specifying how permissions for resources relate to said substructure, said component fitting said template to an instance of said substructure, said component assigning permissions to resources in said instance based on said structural mapping, and said component granting or denying access to a resource based on said permissions.

15. The system of claim 14, said structural mapping comprising a reporting hierarchy within said organization, said template defining a reporting relationship within said organization.

16. The system of claim 14, said structural mapping comprising a geographic grouping within said organization, said template defining a relationship among entities in said organization that are in a same geographic region as each other.

17. The system of claim 14, said structural mapping comprising a substantive grouping within said organization, said template defining a relationship among entities in said organization that work in a same substantive area.

18. The system of claim 14, said component receiving an update to said template.

19. The system of claim 14, said component receiving changes to said permissions, said permissions being assigned to said resources based on said changes.

20. The system of claim 14, said component associating assigned permissions with a name of said template.
